(19) United States
(12) Patent Application Publication
(10) Pub. No.: US 2005/0042931 A1
(43) Pub. Date: Feb. 24, 2005

(54) Reducing cross talk at ethernet connectors

(76) Inventor: Reuven Lavie, Hertzelia (IL)

Correspondence Address: Timothy N. Trop;TROP, PRUNER & HU, P.C., STE 100, 8554 KATY FWY, HOUSTON, TX, 77024-1841, US

(21) Appl. No.: 10/644,416

(22) Filed: Aug. 20, 2003

(51) Int. Cl. H01R 24/00

(52) U.S. Cl. 439/676

(57) ABSTRACT

An Ethernet connector may have capacitively coupled terminals to reduce cross talk. In particular, a near end cross talk may be reduced in some embodiments by coupling non-adjacent channels. For example, non-adjacent channels coupled to complementary signals may be capacitively coupled.

### BACKGROUND

This invention relates generally to Ethernet and, more particularly, to reducing cross talk at Ethernet connectors.

Ethernet is an Institute of Electrical and Electronic Engineering (IEEE) 802.3 standard for connecting network devices on network nodes. By using a network topology including a bus or a star topology and enabling access based on a Carrier Sense Multiple Access with Collision Detection (CSMA/CD), Ethernet regulates traffic on a communication medium to and from Ethernet devices that connect to a network via connectors. For example, network nodes may be linked by a coaxial cable, fiber-optic cable, or twisted-pair wiring through standard connectors including an RJ-45 connector, which is an eight-pin modular connector.

On an Ethernet network, however, different forms of data may be transmitted, such as packets in variable-length frames containing data delivery and control information. In one type of data transmission, known as baseband transmission, tens, hundreds, or thousands of bits of data may be transferred using a variety of Ethernet standards. The IEEE 802.3ab standard defines the connection attributes of such standard connectors for 1000 Base-T Ethernet. This specification is available from The IEEE, Inc., IEEE Customer Service, 445 Hoes Lane, P.O. Box 1331, Piscataway, N.J. 08855-1331, U.S.A.

Fast Ethernet and Gigabit Ethernet use high frequency channels for communication between a transmitter at a network node and a receiver at another network node over a network. Parasitic capacitance may arise between adjacent terminals of a standard connector connecting a twisted pair of conductors. For example, an RJ-45 connector may be used by a telecommunications company for forming a twisted pair connection on four channels, such as channels A, B, C and D.

The parasitic capacitance causes cross talk between adjacent terminals of a standard twisted pair Ethernet connector because some channels may be connected differently than the other channels. Sometimes high frequency channels may be connected as adjacent channels, such as channels B and C. As a result, even though all channels may suffer from certain undesired effects due to cross talk, the cross talk problem may appear relatively exaggerated on the adjacent high frequency channels, i.e., channels B and C since this cross talk may not be interpreted as common noise. This variation in the degree of cross talk across different channels may, in turn, produce undesirable total common noise for a receiver connected via the standard twisted pair Ethernet connector at a network node.

Thus, there is a continuing need for better ways to reduce cross talk due to unwanted coupling at connectors for high speed Ethernet.

### BRIEF DESCRIPTION OF THE DRAWINGS

FIG. 1 is a perspective view of an Ethernet connector consistent with one embodiment of the present invention;

FIG. 2A is a side view of the Ethernet connector shown in FIG. 1 according to one embodiment of the present invention;

FIG. 2B is a top view of the Ethernet connector shown in FIG. 1 according to another embodiment of the present invention;

FIG. 3 is a schematic depiction of capacitive coupling in the Ethernet connector shown in FIG. 1 to reduce near end cross talk in accordance with one embodiment of the present invention;

FIG. 4 shows a perspective view of a network adapter coupled to an Ethernet connector for receiving the twisted pair network cable in accordance with one embodiment of the present invention;

FIG. 5 is a schematic depiction of a processor-based system including the Ethernet connector of FIG. 1 according to one embodiment of the present invention; and

FIG. 6 is a schematic depiction of networking circuitry for the Ethernet connector shown in FIG. 1 consistent with one embodiment of the present invention.

### DETAILED DESCRIPTION

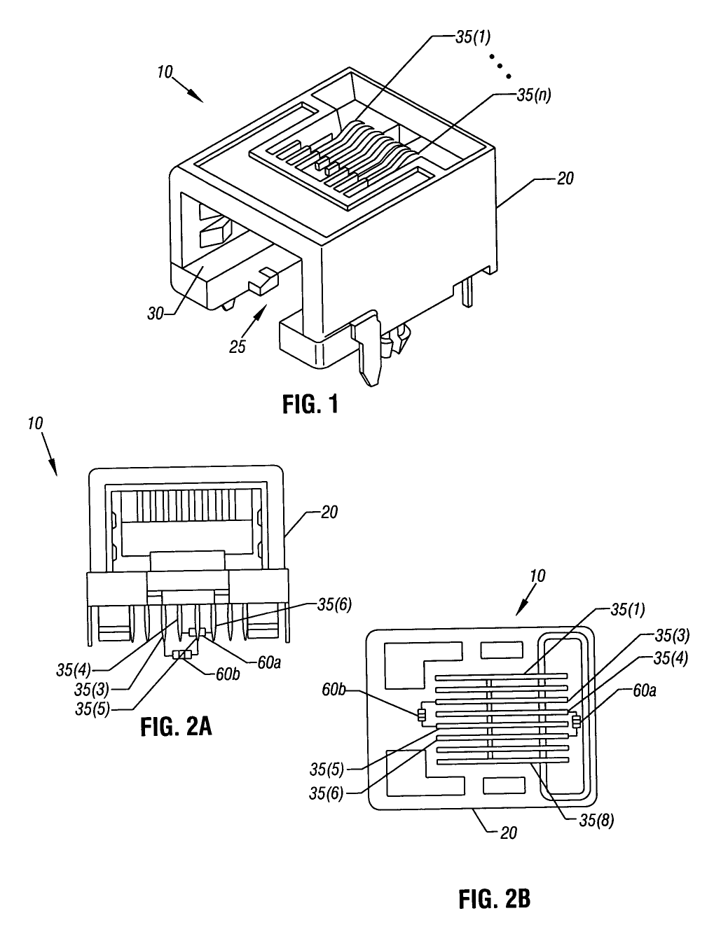

Referring to FIGS. 1, 2A and 2B, an Ethernet connector 10 may include a non-conductive housing 20 forming a jack 25. The Ethernet connector 10 may further include a shield 30 disposed within the non-conductive housing 20 to shield channel communications between a transmitter node and a receiver node over a network.

The connector 10 may be used in networks, such as Ethernet networks adhering to the Fast and Gigabit Ethernet standards. While the Fast Ethernet provides speeds of 100 megabits or millions of bits per second (Mb/s) for the purposes of communicating information over copper and fiber, for example, the Gigabit Ethernet provides speeds of 1,000 Mb/s.

In one embodiment, the Ethernet connector 10 may further include the terminals 35 coupled to the non-conductive housing 20 in order to receive mating Ethernet connectors, forming an Ethernet connection. However, both the Fast and Gigabit Ethernets may use twisted pair cabling or fiber to connect devices to the Ethernet network. In particular, the jack 25 may receive the mating Ethernet connectors from a network cable, such as a copper twisted-pair cable.

Consistent with some embodiments, the Ethernet networks may use twisted pair copper cabling and fiber infrastructures. In some deployments, for instance, the Ethernet networks may use an RJ-45 connector with the desired assignments of the eight pins to transmit or receive information that may travel in the form of typical Ethernet frames on a variety of twisted pair based Ethernet (e.g., 10 BASE-T, 100 BASE-T, or 1,000 BASE-T) connections.

Four channels, denominated A, B, C and D, may be coupled to connector 10 terminals 35 in a predetermined order, such as that specified in the IEEE 802.30b standard. For example, the standard suggests using eight terminals, coupled to channels in the order A+, A−, B+, C+, C−, B−, D+ and D−.

The Ethernet connector 10 may include a first capacitor 60a that couples a first pair of non-adjacent terminals 35(4) and 35(6), in turn coupled to adjacent high frequency channels. In addition, the Ethernet connector 10 may include a second capacitor 60b that couples a second pair of non-adjacent terminals 35(3) and 35(5), in turn coupled to the adjacent high frequency channels.

Consistent with one embodiment, the selected pair(s) of terminals may be coupled to complementary channels (e.g., B+ and C− or C+ and B−). That is, the terminal 35(4) may be coupled to the channel signal C+, and terminal 35(6) may be coupled to channel B−. The terminals 35(4) and 36(6) are in turn coupled to one another through the cross talk reducing capacitor 60a. Likewise, the terminal 35(5) may be coupled to a channel signal B+ while the terminal 35(5) is coupled to channel signal C−. The terminals 35(3) and 35(5) are in turn coupled to one another via the cross talk reducing capacitor 60b.

Cross talk is equalized by decoupling complementary terminals to the disturbing “noise” source. Thus, for example, the capacitor 60a couples C+ to complementary B−, causing complementary cross talk that is interpreted by the receiver as reduced total common noise.

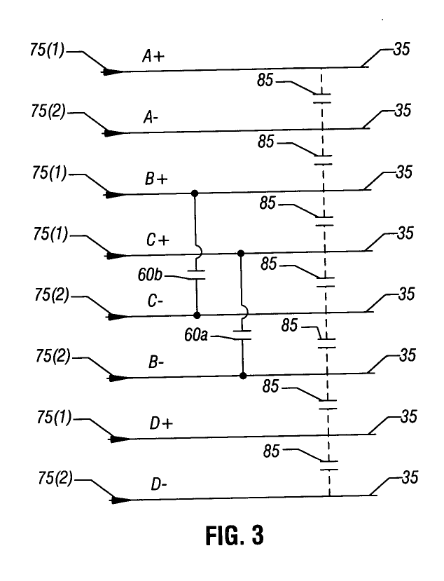

Referring to FIG. 3, capacitive coupling of the selected pairs of the terminals 35 may reduce near end cross talk (NEXT) in the Ethernet connector 10 shown in FIG. 1 in accordance with some embodiments of the present invention. In one embodiment, the Ethernet connector 10 may be an RJ-45 connector. As shown in FIG. 3, four different channels (A, B, C, and D) may couple to a corresponding terminal pair on the eight terminals 35. However, with high frequency channels, such as Fast Ethernet or Gigabit Ethernet channels, the impact of the parasitic capacitance 85 between adjacent terminals is greater, increasing cross talk. Specifically, two complementary channel signals 75(1) and 75(2) may couple to terminals 35, and parasitic capacitance 85 may develop when the complementary high frequency channels form a twisted pair connection.

The terminal 75(1) coupled to the signal B+ is close to the terminal 75(1) coupled to the signal C+. Likewise, the terminal 75(2) coupled to the signal B− is close to the terminal 75(2) coupled to the signal C−. These connections cause double cross talk between channels B and C relative to the more common situation, such as between channels B and D.

In a more common situation, the terminal 75(2) coupled to the signal B− is close to the terminal 75(1) coupled to the signal D+ and a bit further from the terminal 75(2) coupled to the signal D−. Thus, the total cross talk on the channel D is reduced (relative to the cross talk between channels B and C) due to the fact that it is interpreted at the receiver as common noise.

To reduce the cross talk at the terminal B+, the terminal 75(1) having the channel B+ is coupled by the capacitor 60b to the complementary terminal 75(2) bearing the signal C−. Likewise, the terminal 75(1) having the signal C+ is coupled, by the capacitor 60a, to the terminal 75(2) bearing the channel B−. Thus, the cross talk between B+ and C+ as well as between B− and C− is reduced. The signal B+ is coupled through the capacitor 60b to the complementary signal C− while the signal C+ is coupled through the capacitor 60a to the complementary signal B−. The cross talk is equalized by decoupling a complementary terminal to the disturbing noise source while a capacitor causes complementary cross talk that is interpreted by the receiver as reduced total common noise. Thus, the relatively increased cross talk that would otherwise occur in channels B and C is reduced.

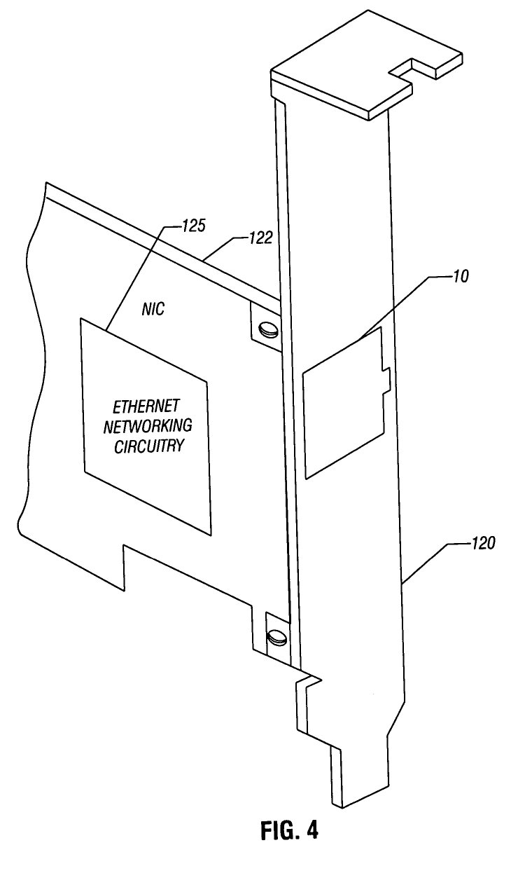

A network adapter 120, shown in FIG. 4, includes the Ethernet connector 10 of FIG. 1 arranged to receive a twisted pair network cable, such as a CAT.5 Ethernet network cable in one embodiment of the present invention. The network adapter 120 may include a network interface card (NIC) 122 coupled to Ethernet networking circuitry 125.

Using the Ethernet connector 10, the network adapter 120 may couple a receiver to an Ethernet network over twisted pair channel connections based on the Ethernet networking circuitry 125. In one embodiment, the Ethernet networking circuitry 125 may enable the network adapter 120 to couple a processor-based system on a multi-Gigabit Ethernet via the network interface card 122. Other network connections compliant with different Ethernet standards, such as Fast Ethernet are also possible in some other embodiments of the present invention. However, known communication protocols, such as a typical Transport Control Protocol (TCP) or a typical Internet Protocol (IP), as two specific examples, may be used for controlling the network traffic on the Ethernet.

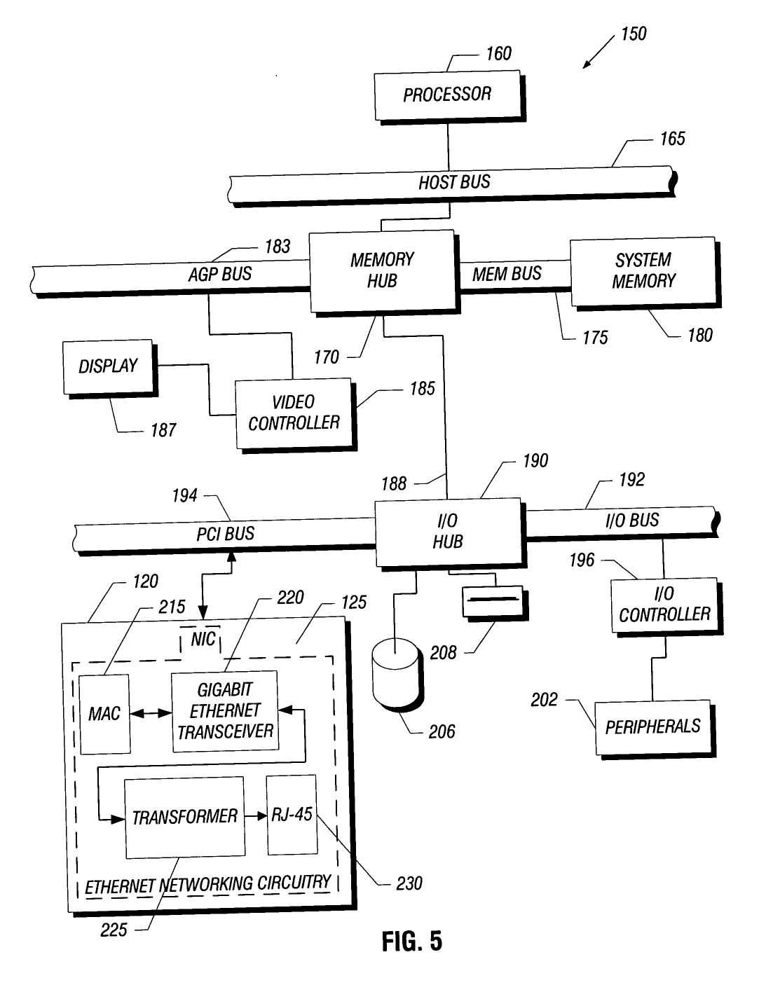

Referring to FIG. 5, a processor-based system 150 includes the network adapter 120 shown in FIG. 4, according to some embodiments of the present invention. The network adapter 120 may include the Ethernet connector 10 depicted in FIG. 1 for receiving a twisted pair network cable in accordance with one embodiment of the present invention. Besides the network adapter 120, the processor-based system 150 may include a processor 160 that is coupled to a host bus 165. Different processing elements or controllers may perform similar operations in other embodiments of the present invention.

In the processor-based system 150, a bridge or a memory hub 170 may couple to the host bus 165. The memory hub 170 may couple the host bus 165 to a memory bus 175, which in turn, may be coupled to a system memory 180 that, for example, may store programs and data for execution. The memory hub 170 may further couple the host bus 165 to an accelerated graphics port (AGP) bus 183. A display 187 may be coupled to the AGP bus 183 via a video controller 185, in some embodiments of the present invention.

The memory hub 170 may further couple to an input/output (I/O) hub 190, which may be a bridge in some embodiments, coupled via a hub link 188 to the memory hub 170. The I/O hub 190 may connect an I/O bus 192 to a Peripheral Component Interconnect (PCI) bus 194. While the PCI bus 194 may be coupled to the network adapter 120, the I/O bus 192 may be coupled to an I/O controller 196 that controls and receives flow of information and data to and from a multiplicity of peripherals 202 in accordance with some embodiments of the present invention.

In addition, the I/O hub 190 may further couple a hard disk drive 206 and a compact disk-read only memory (CD-ROM) drive 208 to the memory hub 170 via the hub link 188 consistent with many embodiments of the present invention. Specifically, the network adapter 120 within the network interface card 122 may include a conventional media access controller (MAC) 215 coupled to a conventional Gigabit Ethernet Transceiver 220, which in turn, may be coupled to a conventional transformer 225 that connects to an RJ-45 connector 230 consistent with embodiments of the present invention.

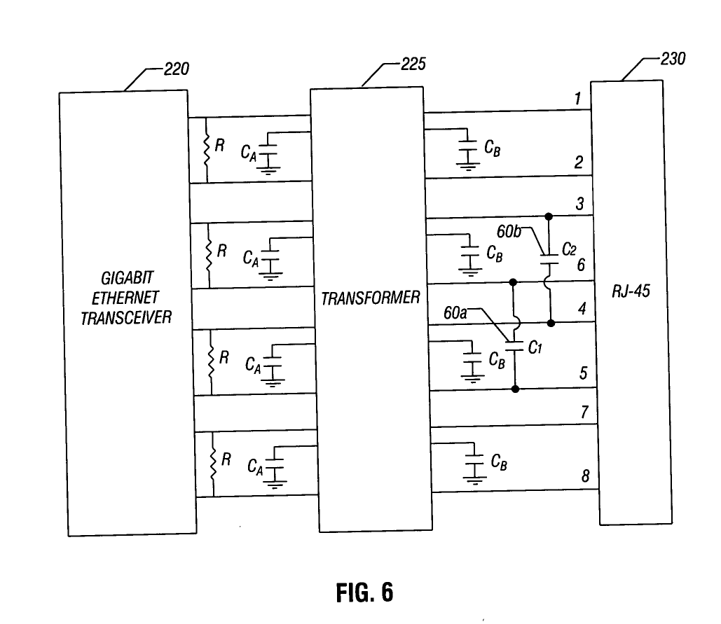

Referring to FIG. 6, the Gigabit Ethernet Transceiver 220 may couple to the transformer 225 over a conventional resistor-capacitor (RC) network including resistors R and capacitors C_{A} of desired values depending upon a particular Ethernet implementation, in some embodiments of the present invention. Likewise, the transformer 225 may couple to the RJ-45 connector 230 via capacitors C_{B} and capacitors C1, 60a and C2, 60b coupled to a selected pair of terminals that receive adjacent high frequency channels.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
capacitively coupling a pair of terminals of an Ethernet connector to reduce cross talk.

2. The method of claim 1 further including:
coupling a first capacitor between a first pair of terminals and coupling a second capacitor between a second pair of terminals.

3. The method of claim 1 further including:
coupling a capacitor between the terminals coupled to B+ and C− channels.

4. The method of claim 3 including coupling a capacitor between the C+ and B− channels.

5. The method of claim 1 including coupling an adjacent channel to a non-adjacent channel by a capacitor.

6. The method of claim 1 including coupling a capacitor between complementary channels.

7. The method of claim 1 including reducing near end cross talk by capacitively coupling non-adjacent channels.

8. A network connector comprising:
a non-conductive housing having a jack;
a plurality of Ethernet terminals to receive Ethernet network signals;
a first capacitor to couple a first pair of said Ethernet terminals; and
a second capacitor to couple a second pair of said Ethernet terminals, said terminals to contact mating Ethernet connectors.

9. (Canceled).

10. The network connector of claim 8 wherein said first pair of terminals include terminals to receive B+ and C− channels.

11. The network connector of claim 10 wherein said second pair of terminals include terminals to receive the C+ and B− channels.

12. The network connector of claim 8 wherein said first pair of terminals are to coupled to complementary channels.

13. The network connector of claim 12 wherein said second pair of said terminals are coupled to complementary channels.

14. The network connector of claim 8 wherein said connector is an Ethernet connector.

15. The network connector of claim 14 wherein said network connector is a fast Ethernet connector.

16. The network connector of claim 14 wherein said network connector is a Gigabit Ethernet connector.

17. A network adapter comprising:
an Ethernet connector having terminals, wherein a selected pair of terminals are capacitively coupled to non-adjacent terminals.

18. The network adapter of claim 17 further comprising:
a network interface card; and
Ethernet networking circuitry located on said network interface card to enable a multi-Gigabit Ethernet connection over a network.

19. The network adapter of claim 18 wherein said Ethernet connector including:
a first capacitor to couple a first pair of said terminals to receive first channel signals and a second capacitor to couple a second pair of said terminals to receive second channel signals.

20. A processor-based system comprising:
a processor; and
a network adapter coupled to said processor, said network adapter including an Ethernet connector having terminals, wherein a pair of said terminals are capacitively coupled.

21. The processor-based system of claim 20, said connector further comprising:
a first capacitor to couple a first pair of said terminals that are non-adjacent and a second capacitor to couple a second pair of terminals that are non-adjacent.

22. The processor-based system of claim 21 further comprising:
a network interface card coupled to said processor; and
Ethernet networking circuitry located on said network interface card to enable a multi-Gigabit Ethernet connection over a network.

23. The processor-based system of claim 22 wherein said Ethernet networking circuitry including:
a first capacitor to couple a first pair of said terminals and a second capacitor to couple a second pair of said terminals of said channels.

24. The processor-based system of claim 23 wherein said first and second capacitors to reduce near end cross talk.
